(19) United States
(12) Patent Application Publication
(10) Pub. No.: US 2022/0044556 A1
(43) Pub. Date: Feb. 10, 2022

(54) SERVER, VEHICLE, TRAFFIC CONTROL METHOD, AND TRAFFIC CONTROL SYSTEM

(71) Applicant: Toyota Jidosha Kabushiki Kaisha, Toyota-shi Aichi-ken (JP)

(72) Inventors: Changyi Luo, Kokubunji-shi (JP); Ayana Takeshita, Kasugai-shi (JP); Yuhei Suzuki, Kariya-shi (JP); Michael C. Edwards, McKinney, TX (US); Chris Risberg, Flower Mound, TX (US)

(21) Appl. No.: 17/393,872

(22) Filed: Aug. 4, 2021

(30) Foreign Application Priority Data
Aug. 7, 2020 (JP) 2020-135383

(51) Int. Cl. G08G 1/01; G08G 1/0967; G08G 1/0965; G08G 1/087; G06Q 30/02; H04W 4/44

(52) U.S. Cl. CPC G08G 1/0141; G08G 1/0145; G08G 1/0112; H04W 4/44; G08G 1/0965; G08G 1/087; G06Q 30/0266; G08G 1/096725

(57) ABSTRACT

A server includes an acquisition interface, a server communication interface, and a server controller. The acquisition interface is configured to be able to acquire traffic information regarding road traffic. The server communication interface is configured to be able to transmit/receive information to/from a plurality of first vehicles that are autonomous. The server controller is configured to instruct a second vehicle selected from the plurality of first vehicles to perform a specific action, in order to control traffic at any spot based on the traffic information.

### CROSS-REFERENCE TO RELATED APPLICATION

This application claims priority to Patent Application No. 2020-135383 filed in Japan on Aug. 7, 2020, the entire contents of which are incorporated herein by reference.

### TECHNICAL FIELD

The present disclosure relates to a server, a vehicle, a traffic control method, and a traffic control system.

### BACKGROUND

Technology to control the braking, steering, and speed of a vehicle that acquires information from roadside infrastructure, such as a traffic signal, by communicating with the roadside infrastructure has been proposed. For example, it is described in Patent Literature (PTL) 1 that a vehicle acquires, from roadside infrastructure, information indicating that speed limitation applies to the vehicle, and when the vehicle is travelling at a speed greater than the limit speed, the brake is controlled so that the speed is less than or equal to the limit speed.

### CITATION LIST

### Patent Literature

PTL 1: US 2018-0129215 A1

### SUMMARY

In conventional technology, information is transmitted to an autonomous vehicle to thereby cause the vehicle to travel in accordance with traffic rules. In the conventional technology, however, autonomous vehicles are not used to control the surrounding traffic situation. If autonomous vehicles are used to control the traffic situation in the vicinity of the vehicles, the traffic situation is expected to improve.

It would be helpful to control traffic using autonomous vehicles.

A server according to an embodiment of the present disclosure includes:

an acquisition interface configured to be able to acquire traffic information regarding road traffic; and

a server communication interface configured to be able to transmit/receive information to/from a plurality of first vehicles that are autonomous; and

a server controller configured to instruct a second vehicle selected from the plurality of first vehicles to perform a specific action, in order to control traffic at any spot based on the traffic information.

A vehicle according to an embodiment of the present disclosure is autonomous. The vehicle includes:

a vehicle communication interface configured to be able to transmit/receive information to/from a server;

a drive system configured to drive the vehicle; and

a vehicle controller configured to control the drive system to perform a specific action of controlling traffic at any spot based on an operation instruction received from the server.

A traffic control method according to an embodiment of the present disclosure is a traffic control method for controlling traffic at any spot based on traffic information regarding road traffic. The traffic control method includes:

acquiring the traffic information;

selecting a second vehicle from a plurality of first vehicles that are autonomous; and

instructing the second vehicle to perform a specific action, in order to control traffic at the spot based on the traffic information.

A traffic control system according to an embodiment of the present disclosure includes:

the server;

the plurality of first vehicles; and

a traffic information collection apparatus configured to collect the traffic information and transmit the collected traffic information to the acquisition interface of the server.

According to the present disclosure, traffic can be controlled using autonomous vehicles.

### BRIEF DESCRIPTION OF THE DRAWINGS

In the accompanying drawings:

FIG. 1 illustrates a schematic configuration of a traffic control system according to an embodiment of the present disclosure;

FIG. 2 is a block diagram illustrating a schematic configuration of a server of FIG. 1;

FIG. 3 is a block diagram illustrating a schematic configuration of a traffic regulation vehicle of FIG. 1;

FIG. 4 illustrates an example of the appearance of the traffic regulation vehicle;

FIG. 5 illustrates First Example of a situation in which the traffic control system performs traffic control;

FIG. 6 illustrates processing executed by a server controller in the example of FIG. 5;

FIG. 7 illustrates an example in which traffic regulation vehicles support alternate traffic;

FIG. 8 illustrates Second Example of a situation in which the traffic control system performs traffic control;

FIG. 9 illustrates processing executed by the server controller in the example of FIG. 8;

FIG. 10 illustrates Third Example of a situation in which the traffic control system performs traffic control;

FIG. 11 illustrates processing executed by the server controller in the example of FIG. 10; and

FIG. 12 illustrates processing executed by a vehicle controller in the example of FIG. 10.

### DETAILED DESCRIPTION

An embodiment of the present disclosure will be described below with reference to the drawings. The drawings used in the following description are schematic. Dimensional ratios or the like on the drawings do not necessarily match actual ones.

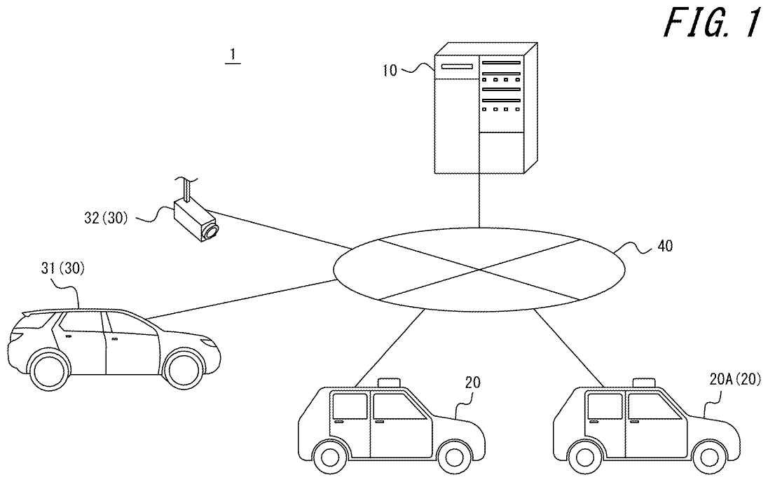

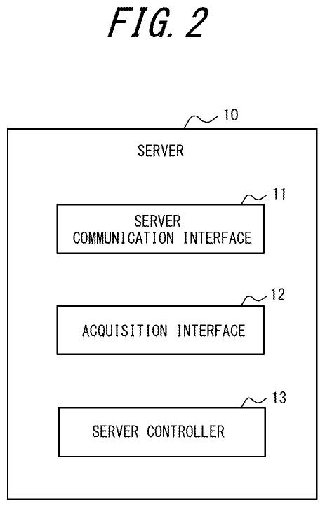

As illustrated in FIG. 1, a traffic control system 1 according to an embodiment includes a server 10 and a plurality of traffic regulation vehicles 20 that are autonomous. The server 10 and the plurality of traffic regulation vehicles 20 are connected to the network 40 and are communicable with each other. Traffic regulation vehicles 20 are first vehicles. The traffic control system 1 may further include traffic information collection apparatuses 30 connected to the network 40. The traffic information collection apparatuses 30 collect traffic information and transmit the collected traffic information to an acquisition interface 12 (refer to FIG. 2) of the server 10. The traffic information collection apparatuses 30 may include traffic information provision vehicles 31 and/or traffic sensors 32. Traffic information provision vehicles 31 are third vehicles.

The server 10 can acquire traffic information regarding road traffic. Based on the acquired traffic information, the server 10 can communicate with traffic regulation vehicles 20, select one vehicle in the traffic regulation vehicles 20 as a designated vehicle 20A, and instruct the designated vehicle 20A to perform a specific action. Designated vehicle 20A are second vehicles. Thus, designated vehicles 20A are included in traffic regulation vehicles 20. The server 10 can acquire various types of traffic information from the traffic information collection apparatuses 30. Traffic information may include information regarding accidents and congestion at particular locations on roads and/or information regarding travel or the like of emergency vehicles. Each component constituting the traffic control system 1 will be described below.

(Configuration of Server)

As illustrated in FIG. 2, the server 10 includes a server communication interface 11, an acquisition interface 12, and a server controller 13.

The server communication interface 11 includes a communication module and is configured to be able to transmit and receive information to and from a plurality of traffic regulation vehicles 20 via the network 40. The server communication interface 11 can perform processing, such as protocol processing pertaining to information transmission and receipt, modulation of transmitted signals, or demodulation of received signals.

The acquisition interface 12 is configured to be able to acquire traffic information regarding road traffic. Traffic information is acquired, for example, from traffic information collection apparatuses 30. The acquisition interface 12 may acquire traffic information from another traffic management server. The acquisition interface 12 may acquire traffic information via the network 40. The acquisition interface 12 may acquire traffic information using a communication path different from the network 40. The acquisition interface 12 may be configured using the same components as the server communication interface 11, whether in part or in the entirety.

The server controller 13 controls the components of the server 10. Processing executed by the server 10 can be referred to as processing executed by the server controller 13. The server controller 13 is configured to be able to control each traffic regulation vehicle 20 via the server communication interface 11. For example, the server controller 13 can generate an operation instruction instructing a designated vehicle 20A selected from a plurality of traffic regulation vehicles 20 to perform a specific action, in order to control traffic at any spot based on traffic information acquired by the acquisition interface 12. The server controller 13 may transmit the generated operation instruction to the traffic regulation vehicle 20 via the server communication interface 11.

The server controller 13 may include at least one processor. The server controller 13 may include various processors. Processors include general purpose processors that execute programmed functions by loading a specific program, and dedicated processors that are dedicated to specific processing. Dedicated processors may include Digital Signal Processors (DSPs), Application Specific Integrated Circuits (ASICs), Field-Programmable Gate Arrays (FPGAs), and the like. The server controller 13 may further include a memory. The memory can store a program executed by a processor, information being operated by the processor, and the like. The memory and the processor are connected by a bus line, such as a data bus and a control bus. The memory may include Read Only Memory (ROM), Random Access Memory (RAM), flash memory, and the like. RAM may include Dynamic Random Access Memory (DRAM) and Static Random Access Memory (SRAM).

(Configuration of Traffic Regulation Vehicle)

Traffic regulation vehicles 20 are vehicles that can operate by automated driving. Travel of each traffic regulation vehicle 20 can be at least partially autonomously controlled. The automated driving may be performed, for example, at any level from Level 1 to Level 5 as defined by the Society of Automotive Engineers (SAE). The automated driving may be performed based on other definitions without being limited to the exemplified definition.

Each traffic regulation vehicle 20 is configured to perform a specific action of controlling traffic at any spot based on an operation instruction received from the server 10. When an instruction from the server 10 has not been received, the traffic regulation vehicle 20 may perform services other than traffic control. Services other than traffic control include, for example, a taxi service of transporting passengers by driverless automated driving, a product delivery service by automated driving, and the like.

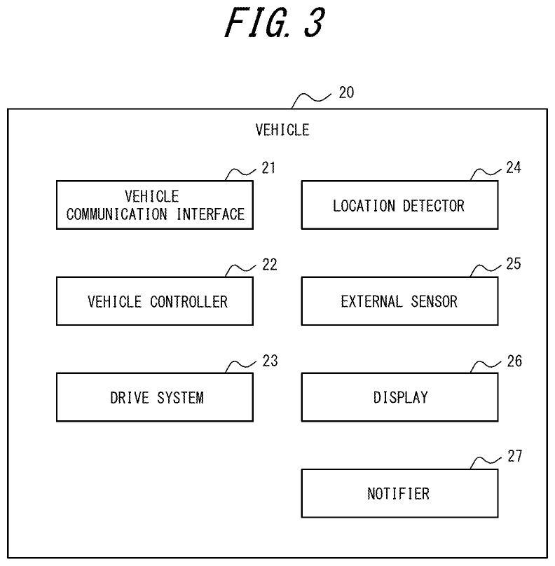

As illustrated in FIG. 3, each traffic regulation vehicle 20 includes a vehicle communication interface 21, a vehicle controller 22, a drive system 23, a location detector 24, an external sensor 25, a display 26, and a notifier 27. The components of the traffic regulation vehicle 20 are communicably connected to each other via an in-vehicle network, such as Controller Area Network (CAN), or a dedicated line.

The vehicle communication interface 21 is configured to transmit and receive information to and from the server 10 via the network 40. The vehicle communication interface 21 may, for example, be an in-vehicle communication device. The vehicle communication interface 21 may include a communication module connected to the network 40. The communication module may include, but is not limited to, a communication module compliant with a mobile communication standard, such as the 4th Generation (4G) or the 5th Generation (5G) standard. As the vehicle communication interface 21, the traffic regulation vehicle 20 may further include a communication module for communicating with other vehicles including a nearby traffic regulation vehicle 20 and a nearby traffic information provision vehicle 31 and/or communication devices of the roadside traffic infrastructure.

The vehicle controller 22 controls the components of the traffic regulation vehicle 20. Processing executed by the traffic regulation vehicle 20 can be referred to as processing executed by the vehicle controller 22. The vehicle controller 22 may include one or more processors. The vehicle controller 22 may include various processors, as is the case with the server controller 13. The vehicle controller 22 may also include various memories, as is the case with the server controller 13. The vehicle controller 22 is configured to control the drive system 23 to perform a specific action of controlling traffic at any spot based on an operation instruction received from the server 10.

The drive system 23 provides functions pertaining to driving of the traffic regulation vehicle 20. The drive system 23 drives the traffic regulation vehicle 20 under the control of the vehicle controller 22. Driving of the traffic regulation vehicle 20 includes slowing down, stopping, reversing, and the like, in addition to normal driving. The drive system 23 includes mechanisms, such as a motor or engine, a transmission, a steering, a brake, a chassis, or tires. The drive system 23 may cooperate with the location detector 24 and the sensor 25 under the control of the vehicle controller 22 for travel by automated driving.

The location detector 24 acquires location information for the traffic regulation vehicle 20. The location detector 24 may include a receiver compliant with Global Navigation Satellite System (GNSS). The receiver compliant with GNSS may include, for example, a Global Positioning System (GPS) receiver. In the present embodiment, it is assumed that the traffic regulation vehicle 20 can acquire the location information for the traffic regulation vehicle 20 itself using the location detector 24. The traffic regulation vehicle 20 may transmit the location information for the traffic regulation vehicle 20 itself to the server 10 via the vehicle communication interface 21.

The external sensor 25 is a sensor for detecting an external environment of the traffic regulation vehicle 20 used for autonomous driving. The external sensor 25 detects persons and objects in the vicinity of the traffic regulation vehicle 20. The external sensor 25 measures a distance from another vehicle in front of the traffic regulation vehicle 20 during travel. The external sensor 25 includes, for example, a Light Detection and Ranging (LIDAR) sensor, a millimeter wave radar, an ultrasonic sensor, and a camera. The camera includes a stereo camera in which a plurality of cameras are arranged in the same direction. The external sensor 25 may further detect anomalies on roads. When the external sensor 25 detects an anomaly on a road, the vehicle controller 22 may notify the server 10 of the anomaly via the vehicle communication interface 21. In a case in which the external sensor 25 includes a camera, the vehicle controller 22 may transmit camera images to the server 10.

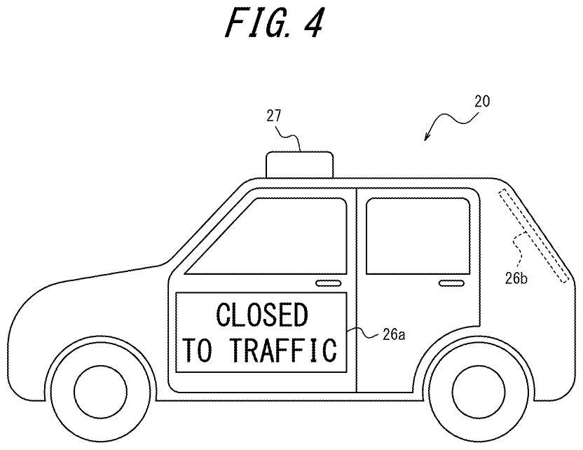

The display 26 is a display apparatus configured to display a character and/or a figure. The display 26 may display warning information for warning other vehicles, instruction information for instructing other vehicles to perform appropriate actions, and the like. The vehicle controller 22 may present a specific display on the display 26 in accordance with an instruction from the server 10 for a specific action. When the traffic regulation vehicle 20 does not perform traffic control, the display 26 may be turned off so as to be inconspicuous. Alternatively, when the traffic regulation vehicle 20 does not perform traffic control, the display 26 may present other displays, such as advertisements, that are not related to traffic control. FIG. 4 illustrates an example of the display 26 of the traffic regulation vehicle 20 that is performing an action pertaining to traffic control. The traffic regulation vehicle 20 illustrated in FIG. 4 has a display 26a on the side of the vehicle and a display 26b on the rear of the vehicle. The arrangement of the displays 26a, 26b of FIG. 4 is exemplary. In practice, the display 26 can be arranged in various ways in the traffic regulation vehicle 20. For example, the display 26 having a display function can be provided on the entire exterior surface of the vehicle body of the traffic regulation vehicle 20.

The notifier 27 informs the outside that a specific action pertaining to traffic control is being performed when the traffic regulation vehicle 20 performs the specific action. The notifier 27 may include a speaker that emits a siren sound and/or a light that emits a flashing light. When performing a specific action pertaining to traffic control, the traffic regulation vehicle 20 can activate the notifier 27 to thereby make drivers or the like of other vehicles recognize that the traffic control is being performed. FIG. 4 illustrates the notifier 27 as a red light as an example. When the traffic regulation vehicle 20 does not perform a specific action for traffic control, the notifier 27 may be stored in the vehicle body so that it is not visible from the outside.

(Traffic Information Provision Vehicle)

Traffic information provision vehicles 31 are vehicles that provide traffic information to the server 10. One example of a traffic information provision vehicle 31 is a vehicle that has a communication function and a detection function for detecting locations, vehicle speeds, and the like, and that is capable of transmitting traffic information to the server 10 by actually travelling on roads. Such a traffic information provision vehicle 31 may also be referred to as a probe vehicle. As traffic information provision vehicles 31, general passenger vehicles, taxis, buses, or the like having the aforementioned functions may be used. Traffic information provision vehicles 31 may be automatically-driven vehicles or human-driven vehicles. A traffic information provision vehicle 31 may acquire congestion information including congested spots, the lengths of congestion, or the like by travelling on roads. A traffic information provision vehicle 31 may detect accidents or the like occurring on roads on which the traffic information provision vehicle 31 is passing, using sensors. Information regarding congestion, accidents, or the like may be automatically detected by sensors and transmitted to the server 10.

Traffic regulation vehicles 20 may have the aforementioned functions of traffic information provision vehicles 31 as probe vehicles. In this case, traffic regulation vehicles 20 may be regarded as being included in traffic information provision vehicles 31.

Another example of a traffic information provision vehicle 31 is an emergency vehicle that should be given priority to travel on roads. Emergency vehicles include ambulance vehicles and fire vehicles. Information regarding an emergency vehicle that is given priority to travel on roads is included in traffic information. An emergency vehicle may transmit, to the server 10, information indicating that the vehicle is travelling to the destination.

Still another example of a traffic information provision vehicle 31 is a vehicle equipped with an accident reporting system (so-called “Mayday System”). In this case, when a traffic information provision vehicle 31 encounters an accident, an emergency reporting signal is transmitted. The emergency reporting signal may be automatically transmitted when the air bag or the like is deployed or may be transmitted in response to the driver of the traffic information provision vehicle 31 operating a switch for reporting an emergency. This signal may be received directly by the server 10. The server 10 may receive information regarding the occurrence of the accident from another organization, such as an accident reporting center that has received the emergency reporting signal.

(Traffic Sensors)

Traffic sensors 32 are sensors installed on and in the vicinity of roads. The traffic sensors 32 include cameras, loop coil sensors, ultrasonic sensors, and the like. In a case in which a camera is used as a traffic sensor 32, the server 10 may acquire a camera image and detect a congested section, an impassable section, or the like on the road from the acquired camera image.

In the following, examples of a traffic control method of the present disclosure will be described by giving an example of situations in which the traffic control system 1 performs traffic control.

### First Example

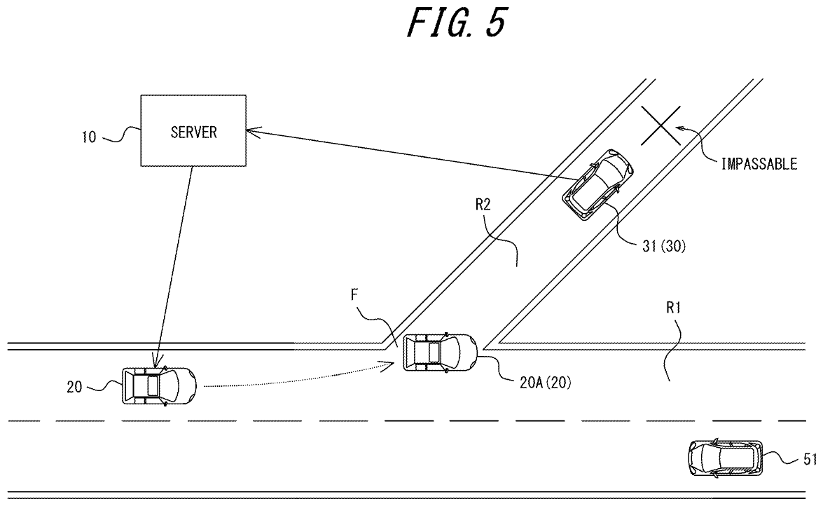

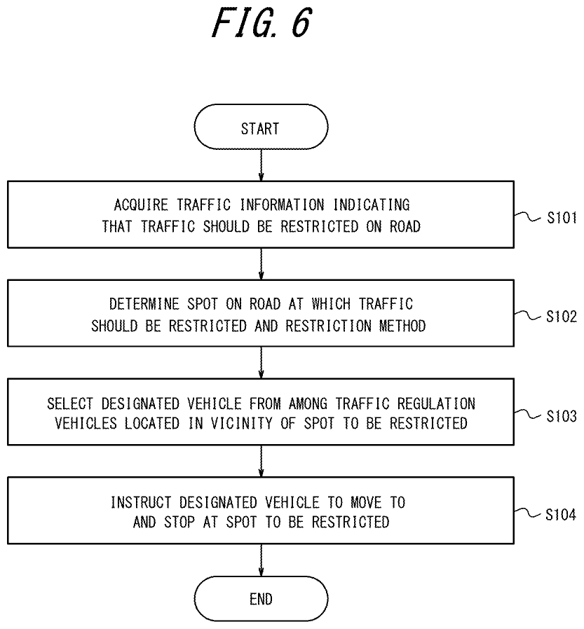

With reference to FIG. 5 and FIG. 6, First Example of a situation in which the traffic control system 1 performs traffic control will be described. FIG. 5 illustrates a situation in which traffic control according to First Example is applied. FIG. 6 illustrates a flow of processing performed by the server 10. In this example, it is assumed that second road R2, which is diverged from first road R1, is impassable ahead as illustrated in FIG. 5. Reasons why second road R2 is impassable may include a traffic accident, a falling rock, flooding due to heavy rain, and the like. In this case, for example, the traffic information provision vehicle 31 which has travelled to the impassable spot detects that second road R2 is impassable and transmits, to the server 10, the detected information together with location information for the impassable spot. The server 10 acquires the above information as traffic information indicating that traffic should be restricted on second road R2 (Step S101).

After acquiring the traffic information, the server 10 determines a spot on the road at which traffic should be restricted and a restriction method, based on the impassable spot, the width of the road, a connection relationship with a nearby road, and the like (Step S102). For example, in the example of FIG. 5, the server 10 determines that traffic should be closed at diverging point F at which second road R2 diverges from first road R1, in order not to allow vehicles to enter second road R2. The location at which second road R2 diverges from first road R1 is the spot at which traffic should be restricted on the road.

Subsequent to Step S102, the server 10 selects a designated vehicle 20A that is to perform traffic control from among traffic regulation vehicles 20 located in the vicinity of the spot to be restricted (Step S103). Any vehicle in traffic regulation vehicles 20 on which a person is on board may be excluded from candidates for the designated vehicle 20A. For example, in a case in which a traffic regulation vehicle 20 is a taxi that is capable of automated driving, the traffic regulation vehicle 20 may be selected as the designated vehicle 20A only if no passenger is on board.

In the example of FIG. 5, the server 10 searches for traffic regulation vehicles 20 located in the vicinity of diverging point F of first road R1 and second road R2. The server 10 may constantly acquire location information from traffic regulation vehicles 20 and manage the information in the memory of the server controller 13. Alternatively, the server 10 may inquire traffic regulation vehicles 20 about the respective locations via the network 40 to thereby search for the traffic regulation vehicles 20 located in the vicinity of diverging point F of first road R1 and second road R2.

The server 10 selects one or more traffic regulation vehicles 20 as designated vehicles 20A from among the traffic regulation vehicles 20 located in the vicinity of diverging point F of first road R1 and second road R2. Designated vehicles 20A may be selected from among a plurality of traffic regulation vehicles 20 heading to diverging point F of first road R1 and second road R2. Designated vehicles 20A may be selected from a plurality of traffic regulation vehicles 20 by considering a congestion condition on the road until each traffic regulation vehicle 20 arrives at diverging point F. The server 10 may estimate arrival times for nearby traffic regulation vehicles 20 at diverging point F of first road R1 and second road R2 and designate the traffic regulation vehicle 20 that can arrive at diverging point F in the shortest time as a designated vehicle 20A.

Upon selecting one or more designated vehicles 20A, the server 10 instructs the one or more designated vehicles 20A to move to and stop at the spot at which vehicles should be restricted (Step S104). In the example of FIG. 5, the server 10 instructs a designated vehicle 20A to move to and stop at diverging point F of first road R1 and second road R2 so that general vehicles 51 will not enter second road R2 at diverging point F (Step S104).

Upon being instructed in Step S104, the designated vehicle 20A travels to diverging point F and stops. This allows the designated vehicle 20A to block general vehicles 51 from entering second road R2. While heading to diverging point F and being stationary at diverging point F, the designated vehicle 20A can inform the outside that traffic control is being performed using the notifier 27. For example, the designated vehicle 20A blinks a red light included in the notifier 27. While being stationary at diverging point F, the designated vehicle 20A can present, on the display 26, that second road R2 is closed to traffic as illustrated in FIG. 4.

The designated vehicle 20A can continuously communicate with the server 10 during the action of performing traffic control. When an emergency vehicle heading to the impassable spot is approaching, the designated vehicle 20A may move so that the emergency vehicle can pass through diverging point F, via communication with the server 10 or via vehicle-to-vehicle communication with the emergency vehicle.

Upon receiving an instruction from the server 10 to terminate the specific action of performing traffic control, the designated vehicle 20A returns to its normal operation. For example, in the example of FIG. 5, upon receiving an instruction from the server 10 to lift the traffic closure, the designated vehicle 20A terminates the specific action of performing traffic control.

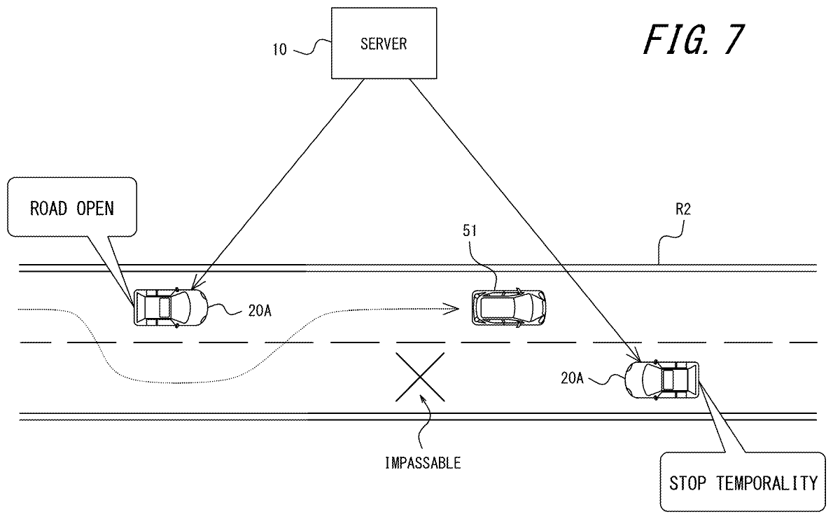

Although in the example of FIG. 5 the designated vehicle 20A closes traffic, the designated vehicle 20A may stop at an appropriate location on second road R2 and operate so as to provide traffic regulation at the spot at which traffic should be restricted. For example, in a case in which only one lane is passable on a road due to some reason, such as an accident or a falling rock, as illustrated in FIG. 7, two designated vehicles 20A may be arranged so as to support single-lane alternating traffic. In this case, the two designated vehicles 20A are arranged across a spot which has become impassable. The server 10 may generate operation instructions that cause the respective displays 26 to display messages indicating whether general vehicles 51 can pass through, and transmit the generated operation instructions to the two designated vehicles 20A. In this case, a passable direction in a section on the road in which traffic is restricted is switched every certain period of time. The server 10 may control the designated vehicles 20A to always allow general vehicles 51 heading to one direction only, via the network 40. Alternatively, the two designated vehicles 20A can perform vehicle-to-vehicle communication, and the respective vehicle controllers 22 may cooperate to control displays on the displays 26 to enable single-lane alternating traffic for general vehicles 51.

### Second Example

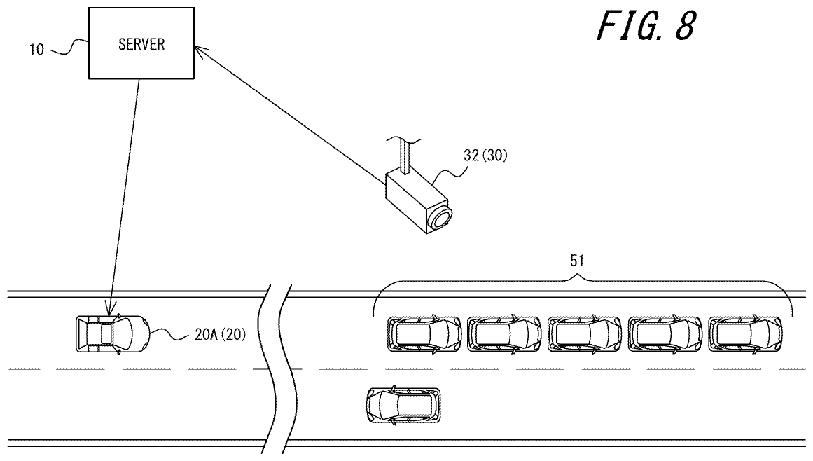

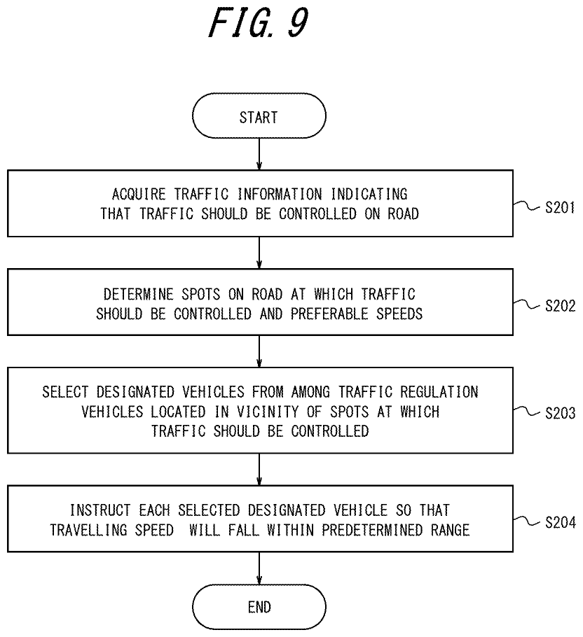

With reference to FIG. 8 and FIG. 9, Second Example of a situation in which the traffic control system 1 performs traffic control will be described. FIG. 8 illustrates a situation in which traffic control according to Second Example is applied. FIG. 9 illustrates a flow of processing performed by the server 10. In this example, it is assumed that congestion caused by general vehicles 51 or the like is occurring on a road, such as a highway, as illustrated in FIG. 8. In this case, the server 10 acquires the occurrence of congestion and its location as traffic information indicating that traffic should be controlled on the road (Step S201). For example, the server 10 may acquire the traffic information from a traffic sensor 32 provided on the road. As the traffic sensor 32, for example, a camera may be used. The congestion on the road can be detected by a known method by processing camera images.

After acquiring the traffic information, the server 10 determines spots at which traffic should be controlled and their speeds (Step S202). For example, the server 10 calculates preferable speeds of vehicles passing through spots located at different distances to the congestion, in order to prevent an increase in congestion due to rapid deceleration occurring immediately before the congestion.

Subsequent to Step S202, the server 10 selects designated vehicles 20A from among traffic regulation vehicles 20 located in the vicinity of the spots at which traffic should be controlled (Step S203). In the example of FIG. 8, the spots at which traffic should be controlled are the spots located at different distances to the congestion for which the preferable speeds have been calculated. The server 10 can select a plurality of designated vehicles 20A. The number of designated vehicles 20A may be large.

Subsequent to Step S203, the server 10 instructs each selected designated vehicle 20A so that the travelling speed will fall within a predetermined range (Step S204). A speed within the predetermined range corresponds to the corresponding preferable speed calculated in Step S202. The predetermined range of speed may be determined by considering an error range acceptable for the preferable speed.

Upon receiving an instruction on travelling speed in Step S204, each designated vehicle 20A adjusts the travelling speed so that the travelling speed will fall within the instructed speed range. When each designated vehicle 20A travels at the corresponding instructed speed, the speeds of general vehicles 51 in the vicinity of the designated vehicle 20A are also expected to be similar to the instructed speed. Thus, the server 10 can control traffic flow at the respective spots before the spot at which congestion is occurring, to thereby prevent an increase in congestion.

### Third Example

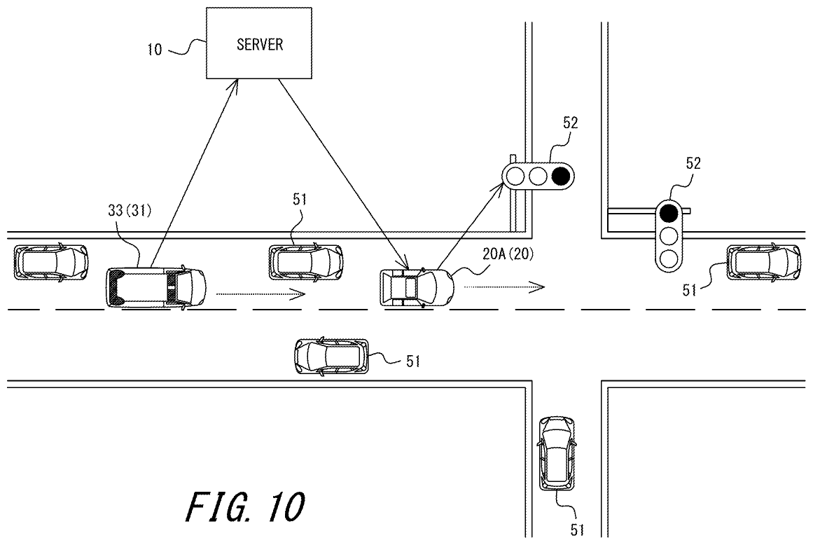

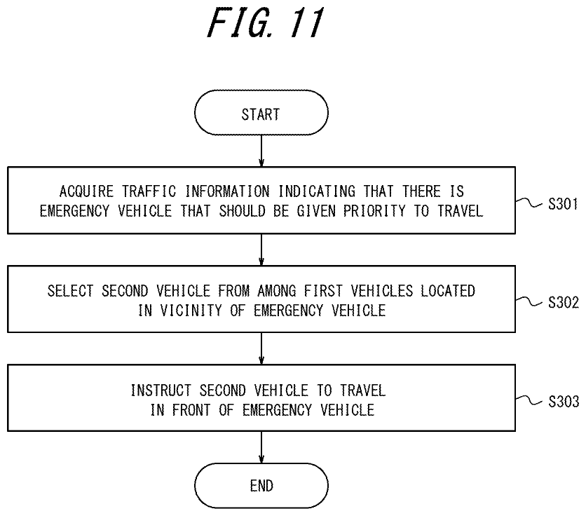

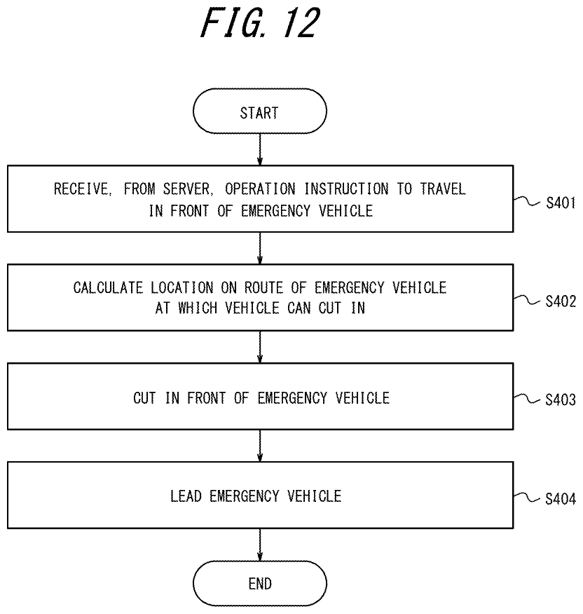

With reference to FIG. 10 to FIG. 12A, Third Example of a situation in which the traffic control system 1 performs traffic control will be described. FIG. 10 illustrates a situation in which traffic control according to Third Example is applied. FIG. 11 illustrates a flow of processing performed by the server 10. FIG. 12 illustrates a flow of processing performed by a traffic regulation vehicle 20. In this example, it is assumed that an emergency vehicle 33 is travelling on a road as illustrated in FIG. 10. The emergency vehicle 33 transmits, to the server 10, information regarding the current location, the destination, the scheduled route, and the like. The server 10 acquires the above information through the acquisition interface 12 as traffic information indicating that there is an emergency vehicle that should be given priority to travel (Step S301).

Upon acquiring the traffic information, the server 10 selects a designated vehicle 20A for leading the emergency vehicle 33 from among traffic regulation vehicles 20 located in the vicinity of the emergency vehicle 33, based on the acquired information regarding the current location of the emergency vehicle 33 (Step S302). The designated vehicle 20A may be selected from traffic regulation vehicles 20 that are found on the road along which the emergency vehicle 33 is passing and located in a direction in which the emergency vehicle 33 is heading. Alternatively, the designated vehicle 20A may be selected from a plurality of traffic regulation vehicles 20 that are able to arrive ahead of the emergency vehicle 33 at an intersection through which the emergency vehicle 33 is scheduled to pass.

After selecting a designated vehicle 20A in Step S302, the server 10 transmits an operation instruction to the selected designated vehicle 20A to travel in front of the emergency vehicle 33 on the route along which the emergency vehicle 33 is scheduled to pass (Step S303). The server 10 may transmit, to the designated vehicle 20A, the current location, the destination, and the scheduled route of the emergency vehicle 33, information or the like that is necessary for direct communication with the emergency vehicle 33, and the like, along with the operation instruction.

Next, processing performed by the designated vehicle 20A will be described. Firstly, in correspondence to Step S303, the designated vehicle 20A receives, from the server 10, the operation instruction to travel in front of the emergency vehicle 33 (Step S401).

Based on location information for the designated vehicle 20A that is detected by the location detector 24, the designated vehicle 20A determines a location on the scheduled route of the emergency vehicle 33 at which the designated vehicle 20A can cut in front of the emergency vehicle 33 (Step S402). The location on the scheduled route of the emergency vehicle 33 at which the designated vehicle 20A can cut in may be calculated by the server 10 and instructed to the designated vehicle 20A.

Subsequent to Step S402, the designated vehicle 20A cuts in front of the emergency vehicle 33 on the scheduled route of the emergency vehicle 33 (Step S403). For this purpose, the designated vehicle 20A may move to the location at which the designated vehicle 20A can cut in front of the emergency vehicle 33. In a case in which the designated vehicle 20A is located on the scheduled route of the emergency vehicle 33, the designated vehicle 20A may be parked on a road shoulder until the emergency vehicle 33 approaches. When the emergency vehicle 33 is approaching, the designated vehicle 20A may cut in front of the emergency vehicle 33. The designated vehicle 20A and the emergency vehicle 33 may communicate with each other through vehicle-to-vehicle communication and may control their travel so that the designated vehicle 20A can cut in front of the emergency vehicle 33 on the route of the emergency vehicle 33.

After cutting in front of the emergency vehicle 33 on the scheduled route of the emergency vehicle 33, the designated vehicle 20A travels while leading the emergency vehicle 33 (Step S404). The designated vehicle 20A may activate the notifier 27 in accordance with an instruction from the server 10 or with a program for the vehicle controller 22, to thereby inform nearby general vehicles 51 that the emergency vehicle 33 is approaching using a siren sound and/or a red light or the like. The designated vehicle 20A may prompt general vehicle 51 travelling on the road to move closer to the road shoulder and slow down or stop in advance, by driving in front of the emergency vehicle 33. This allows the emergency vehicle 33 to travel on the road smoothly.

The vehicle communication interface 21 of each traffic regulation vehicle 20 is configured to be communicable with an emergency vehicle 33, and the vehicle controller 22 can constantly acquire route information to the destination from the emergency vehicle 33 via the vehicle communication interface 21. By doing so, the designated vehicle 20A can quickly follow changes in the destination and the route of the emergency vehicle 33.

The server 10 may cause a plurality of designated vehicles 20A to travel at a distance from each other in front of the emergency vehicle 33. In a case in which the emergency vehicle 33 approaches a designated vehicles 20A travelling immediately in front of the emergency vehicle 33, the designated vehicles 20A may move to the road shoulder so as to let the emergency vehicle 33 pass the designated vehicles 20A. In this case, the designation vehicle 33 will continue to be led by another designated vehicle 20A driving further ahead of the vehicle that was driving immediately in front of the designation vehicle 33. In this way, designated vehicles 20A in front of the emergency vehicle 33 can sequentially generate a path ahead for the emergency vehicle 33 to travel.

Designated vehicles 20A may give the emergency vehicle 33 priority to travel, by communicating with roadside infrastructure, such as traffic lights 52, via roadside-to-vehicle communication or via the network 40. For example, as illustrated in FIG. 10, when a designated vehicle 20A is travelling while leading the emergency vehicle 33, the vehicle controller 22 of the designated vehicle 20A may transmit, via the vehicle communication interface 21 to a traffic light 52 ahead, a signal notifying that the designated vehicle 20A and the emergency vehicle 33 are approaching. This allows the traffic light 52 to change the traffic light 52 to green before the emergency vehicle 33 passes through. Consequently, the emergency vehicle 33 can travel without having to slow down due to a red light at the intersection with the traffic light 52.

As described above, according to the traffic control system 1 of the present disclosure, the server 10 transmits an operation instruction instructing a designated vehicle 20A selected from a plurality of traffic regulation vehicles 20 to perform a specific action based on traffic information. This allows for traffic control using traffic regulation vehicles 20 in travel. In particular, even in a case in which needs for restricting or controlling traffic arise due to accidents or the like in a place away from the headquarter of organizations, such as the police, that manage traffic, the use of traffic regulation vehicles 20 travelling nearby allows for more immediate response. Further, because autonomous vehicles, which are expected to increase in the future, are involved in traffic control, a safer, more secure, and smoother traffic environment can be provided.

While an embodiment of the present disclosure has been described with reference to the drawings and examples, it should be noted that various modifications and revisions may be implemented by those skilled in the art based on the present disclosure. Accordingly, such changes and modifications are included within the scope of the present disclosure. For example, functions or the like included in each means, each step, or the like can be rearranged without logical inconsistency, and a plurality of means, steps, or the like can be combined together or divided.

The method disclosed herein can be performed by a processor included in the server 10 according to a program. The program may be stored in a non-transitory computer readable medium. Examples of non-transitory computer readable media may include, but are not limited to, a hard disk, RAM, ROM, flash memory, a CD-ROM, an optical storage device, and a magnetic storage device.

1. A server comprising:
an acquisition interface configured to be able to acquire traffic information regarding road traffic;
a server communication interface configured to be able to transmit/receive information to/from a plurality of first vehicles that are autonomous; and
a server controller configured to instruct a second vehicle selected from the plurality of first vehicles to perform a specific action, in order to control traffic at any spot based on the traffic information.

2. The server according to claim 1, wherein
the acquisition interface is configured to be able to acquire the traffic information from a third vehicle travelling on a road and/or sensors provided on and in the vicinity of the road.

3. The server according to claim 1, wherein
the traffic information includes information indicating that the road traffic is to be restricted at the spot, that the road traffic is to be controlled, and/or that there is an emergency vehicle that is to be given priority to travel.

4. The server according to claim 1, wherein
the server controller is configured to instruct the second vehicle to move to and stop at a specific location.

5. The server according to claim 1, wherein
the server controller is configured to cause the second vehicle to present a specific display to the outside.

6. The server according to claim 1, wherein
the traffic information includes information indicating that there is an emergency vehicle that is to be given priority to travel, and the server controller is configured to select the second vehicle from one or more first vehicles in the plurality of first vehicles that are located in the vicinity of the emergency vehicle and configured to cause the selected second vehicle to travel in front of the emergency vehicle.

7. The server according to claim 1, wherein
the traffic information includes congestion information, and the server controller is configured to select the second vehicle from one or more first vehicles in the plurality of first vehicles that are heading to a congested spot and is configured to instruct that a travelling speed of the selected second vehicle fall within a predetermined range of speed.

8. A vehicle that is autonomous, the vehicle comprising:
a vehicle communication interface configured to be able to transmit/receive information to/from a server;
a drive system configured to drive the vehicle; and
a vehicle controller configured to control the drive system to perform a specific action of controlling traffic at any spot based on an operation instruction received from the server.

9. The vehicle according to claim 8, wherein
the specific action includes moving to and stopping at a specific location on a road.

10. The vehicle according to claim 8, wherein
the specific action includes travelling in front of an emergency vehicle as instructed by the server.

11. The vehicle according to claim 10, wherein
the vehicle communication interface is configured to be communicable with the emergency vehicle, and the vehicle controller acquires route information to a destination of the emergency vehicle from the emergency vehicle via the vehicle communication interface.

12. The vehicle according to claim 10, wherein
the vehicle communication interface is configured to be communicable with a traffic light, and the vehicle controller is configured to be able to transmit, via the vehicle communication interface to the traffic light, a signal that notifies the traffic light that the vehicle and the emergency vehicle are approaching the traffic light.

13. The vehicle according to claim 8, wherein
the specific action includes travelling within a predetermined range of travelling speed instructed by the server.

14. The vehicle according to claim 8, comprising
a display configured to display a character and/or a figure, wherein
the specific action includes presenting a specific display on the display.

15. The vehicle according to claim 8, further comprising
a notifier that notifies the outside that the specific action is being performed when the specific action is performed.

16. The vehicle according to claim 15, wherein
the notifier includes a speaker configured to emit a siren sound and/or a light configured to emit a flashing light.

17. A traffic control method for controlling traffic at any spot based on traffic information regarding road traffic, the traffic control method comprising:
acquiring the traffic information;
selecting a second vehicle from a plurality of first vehicles that are autonomous; and
instructing the second vehicle to perform a specific action, in order to control traffic at the spot based on the traffic information.

18. The traffic control method according to claim 17, wherein
acquiring the traffic information includes acquiring the traffic information from a third vehicle travelling on a road and/or a sensor provided on the road.

19. The traffic control method according to claim 17, wherein
the traffic information includes information indicating that the road traffic is to be restricted at the spot, that the road traffic is to be controlled, and/or that there is an emergency vehicle that is to be given priority to travel.

20. A traffic control system comprising:
the server according to claim 1;
the plurality of first vehicles, each vehicle of the plurality of first vehicles comprising: a vehicle communication interface configured to be able to transmit/receive information to/from the server; a driving system configured to drive the vehicle; and a vehicle controller configured to control the driving system to perform a specific action of controlling traffic at any spot based on an operation instruction received from the server; and
a traffic information collection apparatus configured to collect the traffic information and transmit the collected traffic information to the acquisition interface of the server.
